(19) United States
(12) Patent Application Publication
(10) Pub. No.: US 2021/0246935 A1
(43) Pub. Date: Aug. 12, 2021

(54) PIN LOCK ASSEMBLY

(71) Applicant: ESCO GROUP LLC, Portland, OR (US)

(72) Inventors: Christopher E. Grewell, Portland, OR (US); Shawn M. McCullum, Beaverton, OR (US); Dustin L. Ashford, Portland, OR (US); Lee A. Zimmerman, Portland, OR (US); Craig D. Lechtenberg, Portland, OR (US)

(73) Assignee: ESCO Group LLC, Portland, OR (US)

(21) Appl. No.: 17/169,302

(22) Filed: Feb. 5, 2021

Related U.S. Application Data
(60) Provisional application No. 62/971,900, filed on Feb. 7, 2020.

(51) Int. Cl. F16C 11/10; E02F 3/60; F16C 11/02

(52) U.S. Cl. CPC F16C 11/10; F16C 2350/26; F16C 11/02; E02F 3/60

(57) ABSTRACT

A pin assembly for a component, such as a trunnion bracket, includes a pin received in pin hole of the component, and a retainer received in a retainer opening of the component to releasably secure the pin in the pin hole. The retainer can be secured to the pin, such that the pin and lock assembly rotate as a single component.

### RELATED APPLICATIONS

This application claims priority to U.S. Provisional Patent Application No. 62/971,900, filed Feb. 7, 2020, which is incorporated by reference in its entirety herein and made a part hereof.

### BACKGROUND OF THE DISCLOSURE

Pins are commonly used to join components that rotate in relation to each other. A pin passes through openings in each of the components and is retained by mechanical means such as friction or by use of a retainer(s) on the pin or component. Sides defining the openings and the pin surface form bearing surfaces as the component pivots.

Mining equipment uses pins extensively to join very large components used in highly abrasive environments. Dragline excavating systems have long been used in mining and earth moving operations. Unlike other excavating machines, dragline buckets are controlled and supported solely by rigging components, such as cables and chains. To a large extent, the stability and performance of the bucket in operation must come from the construction of the bucket and the rigging components.

FIG. 1 shows a dragline bucket system 10 used in open pit mining operations with rigging for moving the bucket. The rigging handles extreme loads in pulling the bucket to collect earthen material and lifting the filled bucket. The bucket 12 is pulled forward by drag chain 16 attached to hitch 18 on the front of the bucket by drag links 14. Teeth 15 on the lower lip engage and initially gather the earthen materials into the bucket.

Once filled, the bucket 12 is lifted by cables connected to an upper hoist rigging assembly 20 connected to the bucket by upper hoist chains 22 and lower hoist chains 24 connected to trunnions or trunnion brackets 26 of the bucket 12. The connections between the cables, chains and the bucket include one or several pins to secure the rigging components to adjacent rigging components.

The dragline bucket trunnions or trunnion brackets are fittings, provided on interior walls or exterior side walls of a bucket, to which the lower hoist chains 24 are connected. In the illustrated example, the trunnions brackets 26 are located on the exterior walls. The trunnion locations are calculated from the center of gravity of the bucket 12 so as to carry a loaded bucket 12 in the air tilted back at an angle and also to carry the bucket in a vertical position after it has dumped the load, i.e., with the front of the bucket 12 hanging down.

A trunnion 26 typically has a pair of arms defining a U-shape and having a valley therebetween and a pair of aligned apertures on opposite sides of the valley so that a pin 27 is supported by the pair of apertures and traverses the valley. Each trunnion 26 may include two pairs of apertures, in either of which pair the pin 27 may be located. Each aperture pair represents a position or pivot point, which may be selected for the desired displacement relative to the center of gravity.

Further, the bucket and rigging components are exposed to a highly abrasive environment where dirt, rocks, fine earthen material, and other debris abrade the rigging and the dragline bucket as they contact the ground. Connections between rigging elements also experience wear in areas where they bear against each other and are subjected to various forces. Following a period of use, therefore, the dragline excavating system must be subjected to periodic maintenance so that various parts can be inspected, replaced or repaired. In most modern systems, there are many parts that require such inspection, repair or replacement and it takes significant downtime of the operation to complete the needed tasks. Such downtime decreases the production and efficiency of the dragline operation.

### SUMMARY OF THE DISCLOSURE

Pin connections are used in a wide variety of equipment working in, but not limited to, various earth working environments. For example, pin assemblies are used in a wide range of mining, dredging, forestry, and construction equipment.

In one example, a pin assembly is used in mining. Mining equipment generally operates in abrasive environments where dust and debris can penetrate every crevice. Even components that are not intended to contact the earthen materials are affected by the sand, earthen material, fines, and dust generated during processing. A pin assembly in accordance with the present disclosure can reduce the handling of the components, the time required for installing and removing pins from equipment, and/or the downtime required for maintenance.

In one embodiment, pin assembly including a component having a pin hole and a retainer opening. A pin is received in the pin hole, and a retainer is fixed to the pin and releasably secured within the retainer opening to prevent the removal from and the turning of the pin in the pin hole.

In another embodiment, a pin assembly including a component having a pin hole and a retainer opening, wherein the pin hole is aligned with the retainer opening. A pin received in the pin hole, and a retainer is received in the retainer opening to prevent removal of the pin from the pin hole, wherein the retainer includes at least one lock to releasably secure the retainer in the opening.

In another embodiment, a pin assembly includes a component defining two pin holes and a retainer opening communicating with the pin holes. A pin is alternatively receivable in either of the two pin holes, and a retainer is releasably securable in the retainer opening to prevent the removal of the pin from either of the pin holes.

In another embodiment, a pin assembly includes a component defining two pin holes and a retainer opening, a pin alternatively receivable in either of the two pin holes, and a retainer fixed to the pin and releasably secured within the retainer opening to prevent the removal from and the turning of the pin when the pin is in either of the pin holes.

In another embodiment, a pin assembly includes a component defining a pin hole and a retainer opening. A pin is received in the pin hole, and a retainer is received in the retainer opening to prevent removal of the pin from the pin hole. The retainer includes a body having opposite sides and a pair of locks secured to the body with one said lock associated with each of the opposite sides. Each of the locks includes a retaining member movable inward and outward of the body to releasably secure the retainer in the retainer opening.

In another embodiment, a pin assembly includes a pin, and a retainer fixed to the pin for receipt into a component having a pin hole for receiving the pin and a retainer opening for receiving the retainer. The retainer includes at least one lock having a collar secured to the retainer and a lock pin threaded into the collar for translating when turned between a hold position for securing the retainer in the retainer opening and a release position for permitting installation of the retainer into the retainer opening.

In another embodiment, a pin assembly for earth working equipment includes a pin having a body sized and shaped for being received into an opening of a rigging component of the earth working equipment. A retainer includes a body having a pin opening for receiving at least a portion of the pin. The retainer is secured to the pin such that the pin does not move independently of the retainer. At least one lock is secured to the body and is operable to releasably secure the retainer to the rigging component. The retainer includes a lock access opening to enable access to and operation of the at least one lock.

In another embodiment, a trunnion assembly includes a bracket having two arms opposing each other. Each of the arms includes a pair of spaced pin holes for receiving pins to secure the bracket to a rigging component. One of the arms includes an outer surface with a retainer opening that encompasses each of the pin holes and is adapted to receive a retainer to releasably secure the pin in either of the pin holes. The retainer opening includes a recess to receive a lock component to secure the retainer in the retainer opening.

In another embodiment, a dragline bucket includes a shell having opposite sidewalls, wherein each of the sidewalls has a trunnion bracket for securing to a rigging component. Each of the trunnion brackets defines a pin hole and a retainer opening. A pin is received in the pin hole, and a retainer is received in the retainer opening to prevent removal of the pin from the pin hole, wherein the retainer includes at least one lock to releasably secure the retainer in the opening.

In another embodiment, a pin assembly for earth working equipment includes a pin having a body being sized and shaped to be received into an opening of a rigging component of the earth working equipment, and a retainer having a pin opening for receiving at least a portion of the pin and securing to the pin such that the pin and lock assembly rotate as a single component. The retainer includes a lock access opening having a lock passage for situating a lock therein. Once the lock is situated into the lock passage, the pin lock assembly is fixed to the rigging component of the earth working equipment. In one example, the rigging component is a trunnion bracket.

In another embodiment, the pin assembly includes a pin and a retainer. The retainer includes a tool access aperture that communicates with the lock access aperture. In one example, the lock access aperture includes two cavities and a lock passage in each cavity. In another example, the lock passages are in opposite directions with each lock passage being in a direction transverse to and non-communicative with the pin aperture. In another example, the retainer includes at least one lock situated in the lock passage. In another example, the at least one lock includes a collar. In another example, the collar includes lugs that engage bearing surfaces in the lock passage.

In another embodiment, a trunnion assembly includes a bracket with two arms and two holes that pass through both arms, and a retainer opening located on the outer of the two arms and surrounding the two holes. The retainer opening is sized and shaped like an elongate circle. The assembly includes a pin and retainer secured together. The pin is fit into at least one of the holes and the retainer into the retainer opening in a first position. The pin assembly is removable and rotatable such that the pin is situated into the other hole and the retainer into the retainer opening in a second position.

In another embodiment, a trunnion assembly includes a bracket with two arms and two holes that pass through both arms, and a retainer opening located on the outer of the two arms and surrounding the two holes. The assembly includes a pin and retainer secured together. The pin is fit into at least one of the holes and the retainer into the retainer opening in a first position. The pin assembly is removable and rotatable such that the pin is situated into the other hole and the retainer into the retainer opening in a second position. At least one slot located within the lock assembly aperture and at least a portion thereof are aligned with the lock passage. The bracket includes at least one slot situated adjacent the retainer opening. The slot extends transverse to and communicates with the retainer opening. The slot is sized and shaped such that opposed locks will engage the slot in either orientation of the retainer.

In another embodiment, a hammerless lock is secured in a lock passage of a retainer retaining the pin in a component. The lock is adjustable to alternatively retain the pin and release the pin to permit installation and removal of the pin from the pin opening. The lock is retained to the pin lock assembly in the lock passage when securing the pin and when releasing the pin. In one example, a retainer can lock a joint pin in a fixed state against rotational movements in a reliable manner.

### BRIEF DESCRIPTION OF THE DRAWINGS

The foregoing Summary and the following Detailed Description will be better understood when read in conjunction with the accompanying figures.

FIG. 1 is a perspective view of known rigging components and a dragline bucket.

FIG. 2 is a side view of a dragline bucket in accordance with one example of the present disclosure.

FIG. 3 is a perspective view of a trunnion bracket and trunnion pin assembly of the dragline bucket shown in FIG. 2.

FIG. 4 is a cross-section along plane 4-4 of FIG. 3 showing in more detail a trunnion pin positioned within the trunnion bracket of FIG. 3.

FIG. 5 is a perspective view of the trunnion pin assembly of FIG. 3.

FIG. 6 is an exploded view of the trunnion pin assembly of FIG. 3.

FIG. 7 is a perspective view of the pin assembly of FIG. 3.

FIG. 8 is a perspective exploded view of the pin assembly.

FIG. 9 is a cross-section view from section 9-9 in FIG. 5 of the lock installed in the lock passage.

FIG. 10 is a partial perspective view of the lock passage prior to insertion of any part of the lock.

FIG. 11 is a partial perspective view of a mounting component of the lock partially installed the lock passage of FIG. 9.

FIG. 12 is a partial perspective view of the mounting component of the lock fully installed in the lock passage of FIG. 10.

FIG. 13 is an exploded perspective view of a retainer, the lock and the lock passage.

FIG. 14 is a cross-section from section 14-14 of FIG. 3 of a trunnion pin assembly located in a first position within a trunnion arm of the trunnion bracket of FIG. 3.

FIG. 15 is an equivalent cross-section to FIG. 14 but showing a trunnion pin assembly located in a second position within the trunnion arm of the dragline bucket of FIG. 2.

### DETAILED DESCRIPTION OF THE INVENTION

Mining operations commonly require large and heavy rigging to handle dragline buckets, heavy shovels, and other equipment used in open pit mines. The rigging uses pins to hold many of the rigging components to the dragline bucket, other equipment and/or other rigging components. In operation, these pins and components are exposed to heavy loading and abrasive particles that abrade the rigging components and/or components connecting to the rigging. These particles, combined with the extreme loads applied to the pins, limit the service life of the pins and associated components by eroding exposed surfaces until the components are not serviceable. Inspection and/or refurbishing such rigging components and/or equipment requires the handling of parts weighing up to several tons and aligning combinations of parts to accommodate the assembly and disassembly of the pins from the components. Handling these large parts can be dangerous for the operators and can take the equipment out of service for long periods. The discussion herein with respect to mining equipment is not meant to be limiting, as the pin assembly in accordance with the present disclosure is usable in other earth working, forestry and other operations where large industrial connection pins subjected to heavy loads are used.

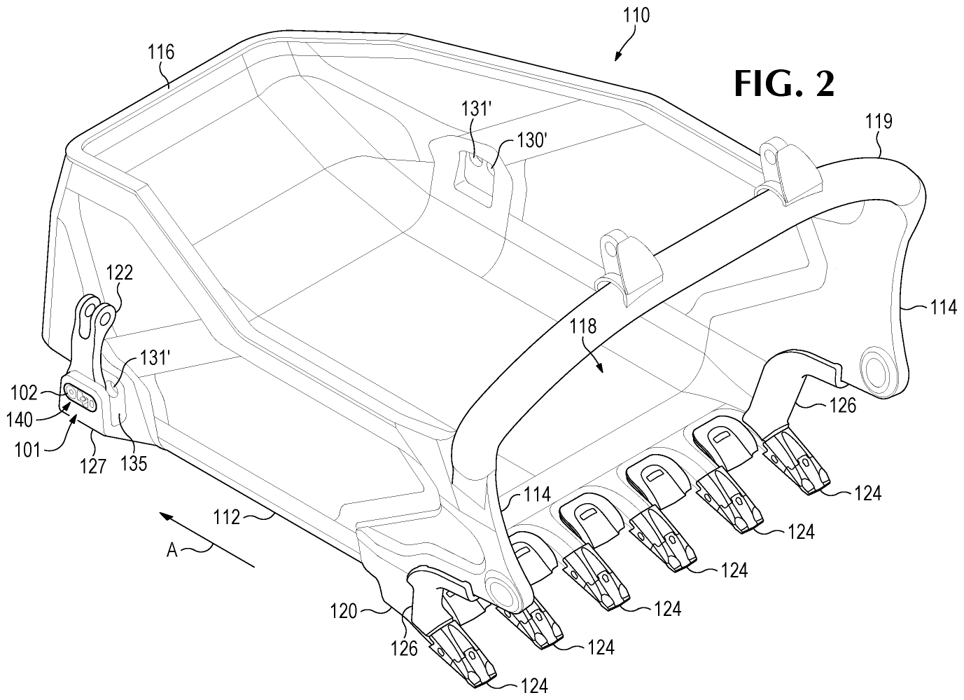

Referring to the Figures, and particularly to FIG. 2, a dragline bucket 110 in accordance with one example of the present disclosure includes a bottom wall 112, sidewalls 114, and a rear wall 116 to define a bucket cavity 118 for receiving and collecting the earthen material in an excavating operation. A front of the bucket is open and bounded by the bottom wall 112, the sidewalls 114, and an arcuate support brace 119 extending between the sidewalls 114 and providing fixtures to which dump ropes may be coupled. Other dragline constructions are also possible.

A lip 120 is provided along the front of bottom wall 112. Lip 120 extends across the width of cavity 118 between sidewalls 114. Excavating teeth and/or shrouds 124 and wings 126 of various designs are mounted along the lip 120 and bucket to improve digging and protect the lip 120. Abrasive material contact generally flows in direction A. The dragline bucket 110 has two trunnion brackets 127, each fixed (for example, by welding) to one of the sidewalls 114 to connect directly or indirectly to hoist links 122 which link to hoist chains as described above.

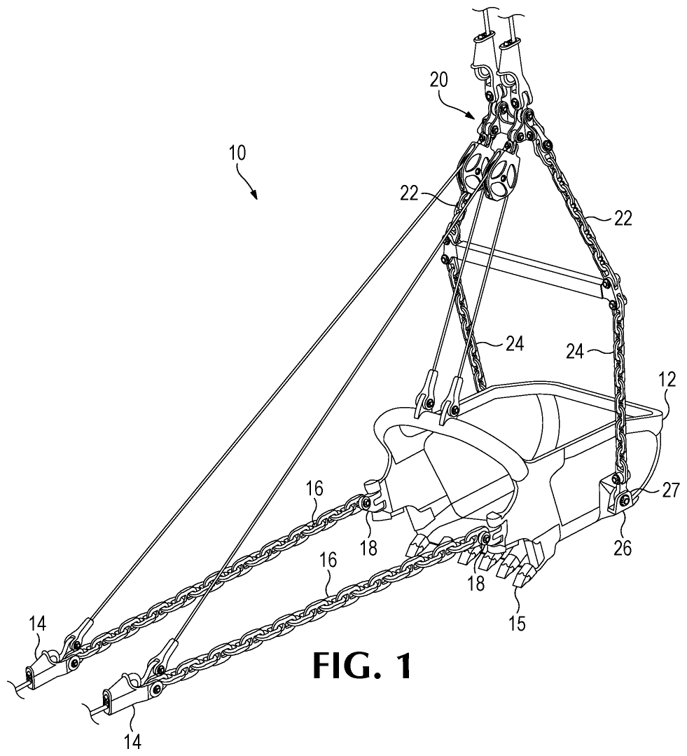

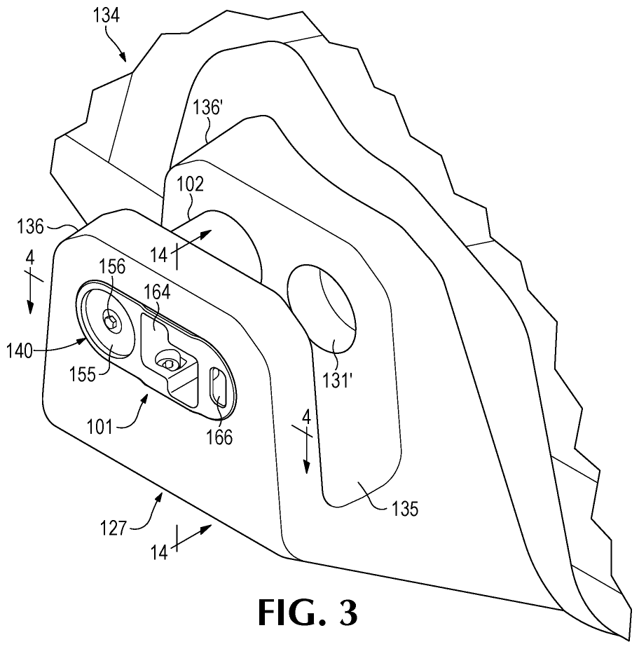

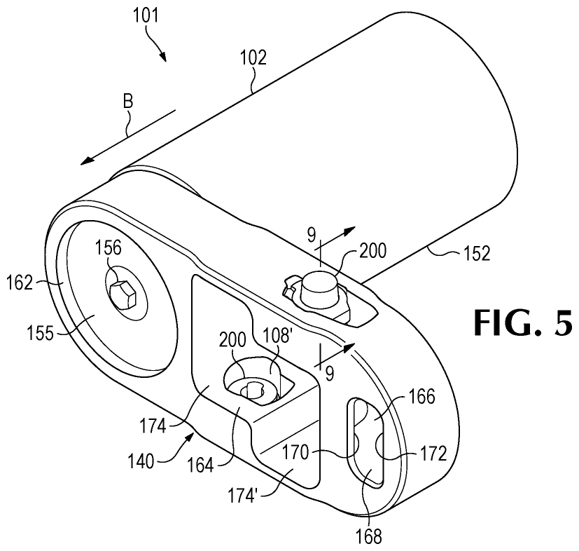

Reference is now made to FIGS. 3-6, which show one of the trunnion brackets 127 in more detail. In this example, a trunnion pin 102 can be installed in the rear pin hole 130A or the front pin hole 131A depending on the operation of the bucket. A U-shaped trunnion bracket 127 is a common rigging wear component for connecting rigging components as shown in FIG. 1 and is used herein as an example. Though other shapes are possible, e.g. Y-shaped or C-shaped. The U-shaped trunnion bracket 127 is depicted here as an example only for the purpose of illustration. The teaching of this disclosure can be applied to other pinned components in addition to the illustrated trunnion bracket 127.

Trunnion bracket 127 includes a body 134 having arms 136 and 136′ extending in the same general direction separated by a valley 135 defined therebetween. Arm 136 has two pin apertures 130, 131 that individually align with respective pin apertures 130′, 131′ on arm 136′ to define the two pin holes 130A, 130B. Holes 130′, 131′ may continue through the bucket sidewall 114 (FIG. 2). The pin 102 passes through a set of the openings 130,130′ or 131, 131′ and traverses the valley 135 to engage both arms 136, 136′ and in some cases the bucket sidewall 114 itself. In the illustrated example, another rigging component, e.g. chain link 122, may be received in the valley 135 between the arms 136, 136′, and may define a chain link aperture through which the pin 102 extends so that the pin 102 creates a pivot point for the dragline bucket 110.

The trunnion bracket 127 further includes a retainer opening 142 in an outer portion of arm 136 for receiving a retainer 140 to secure the pin 102 in the bracket 127. The retainer opening 142 is co-axial with opening 130 and opening 131, which are formed in an inner portion of arm 136. While retainer opening 142 extends across both openings 130, 131, a medial wall 143 in the inner portion of arm 136 exists between openings 130 and 131 to separately define each opening and contact the received pin. In the illustrated example, the retainer opening 142 is generally oval or an elongated circle; however, in other examples, the middle portion may be constricted or enlarged compared with an elliptical shape. Other shapes could also be used. The retainer opening 142 is dimensioned to accommodate the retainer 140 therein. The retainer 140 includes one or more locks 200 to secure the retainer 140 in the retainer opening 142.

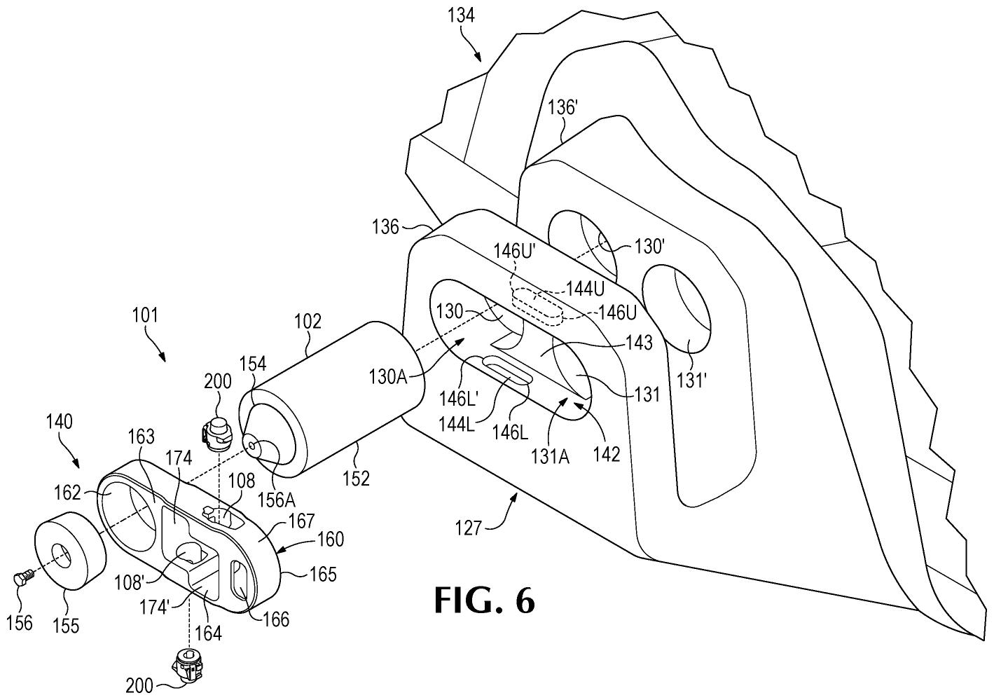

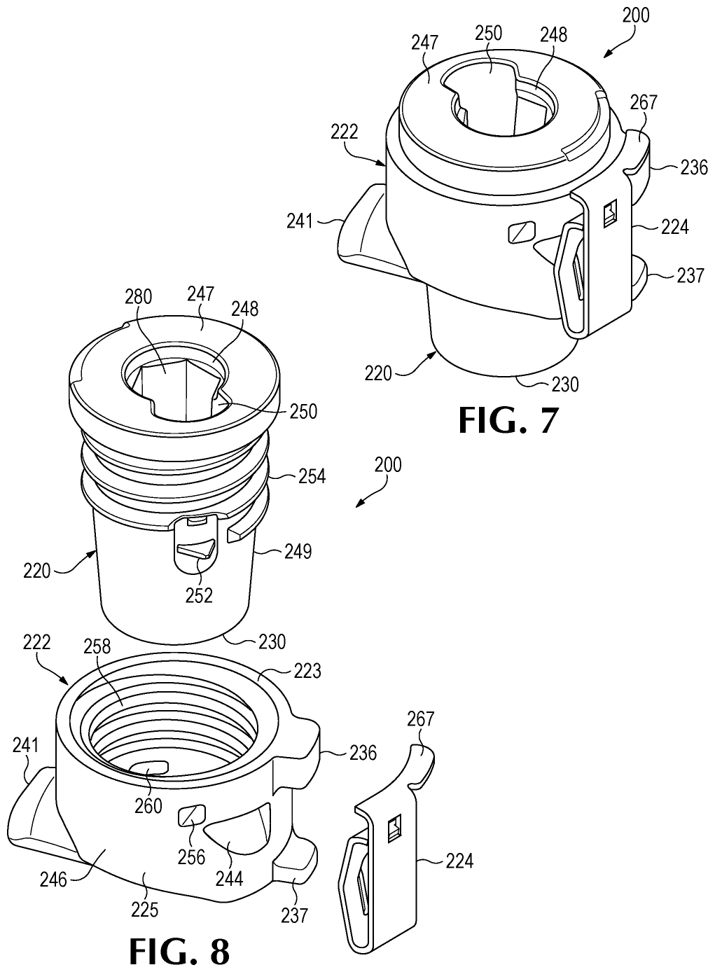

The retainer opening 142 includes at least one recess or slot 144 to receive a lock 200 to secure the retainer in place. In the illustrated example, two recesses or slots are provided, e.g. upper and lower slots 144U, 144L (best seen in FIG. 6). In the illustrated example, the slots 144U, 144L are positioned above and below a middle of the retainer opening 142 and extend in opposite directions parallel to direction A (FIG. 1) and offset from each other in direction A. Nevertheless, the recesses could be defined by a plurality of spaced recesses instead of a single elongated recess, they could be aligned with each other and/or they could be in different positions than shown in the figures. In the illustrated embodiment, each of the slots 144U and 144L has opposed ends (146U and 146U′ for slot 144U; 146L and 146L′ for slot 144L) that are sized and shaped such that a lock end 230 (FIG. 7) of a first lock 200 engages one of the ends of the upper slot (146U or 146U′) and a lock end 230 of a second lock 200 engages one of the ends of the lower slot (146L or 146L′), when the retainer 140 is positioned into a first position. The lock ends 230 need not be fit against an end of the slot.

In the illustrated embodiment, the retainer 140 can be inserted into the retainer opening either orientation, i.e., with the pin aperture 162 aligned with either pin hole 130A, 131A. When the retainer 140 is removed and rotated (e.g. by 180 degrees) for the installation of pin 102 into the front pin hole 130B, the retainer 140 can be inserted into the retainer opening 142 in a second inverted position. In the second position, the lock ends 230 will engage the opposite respective ends in the upper and lower slots 144U, 144L. This reversibility remains the same whether retainer 140 is fixed to the pin 102 to prevent rotation of pin 102 or whether the retainer only prevents removal of the pin from the bracket. In some situations where a pin head is not received into a pin aperture in the retainer and is not fixed to the retainer, the retainer could retain be secured in the same way regardless of which pin hole the pin is installed into.

In the illustrated example, the pin assembly 101 includes the pin 102 and the retainer 140. The pin 102 as shown includes a pin body 152 and a pin head 154 but other pin constructions are possible. Pin 102 can be a cylindrical pin with or without a defined head. In one example, both the pin body and the pin head are cylindrically shaped with the pin head having a smaller diameter than the pin body. In the illustrated example, the pin head 154 has a frusto-conical shape. The pin head 154 includes a threaded bolt 156 received in a threaded hole 156A that may be a placeholder for an attachment means, such as a lifting eye including a threaded stem. Other arrangements are possible.

In the illustrated example, the retainer 140 includes a body 160 (FIG. 6) including a pin aperture 162, a lock access opening 164, and a tool access opening 166. The body 160 has a front face 163, a back face 165, and a side surface 167 joining the front and back faces. The thickness of the body 160 may be such that the retainer 140 is recessed or flush with the exterior surface of arm 136 when inserted into retainer aperture 142 (best seen in FIG. 3), though other arrangements are possible. In the illustrated example, the thickness of the body 160 is greater than the thickness of the frusto-conical head 154. Weld material 155 can be used to hold the pin 102 in the bracket 127 and prevent the pin from turning. Alternatives to welding the pin to the retainer are possible. For example, pin aperture 162 could be smaller than the pin body diameter to retain the pin in the bracket without the use of welding, particularly when rotation of the pin is permitted. Other securing arrangements (with or without pin rotation) are also possible. As another example, the pin could be formed as a single piece with the retainer and installed and removed as a unit.

In the illustrated example, the pin aperture 162 is defined by body 160 to receive the pin head 154, and is cylindrical in shape (though other shapes are possible). The pin aperture 162 is slightly larger than the wide end of the frusto-conical pin head 154. The frusto-conical shape of the pin head 154 creates a gap between the pin head 154 and the pin head aperture 162 to allow the weld material 155 to be enclosed therein. The weld material 155 can be flush or recessed from an outer face 163 of the arm 136 and retainer 140 when installed, and couples the pin 102 to the retainer 140 to create a single piece unit 101. The pin head aperture 162 preferably does not communicate with the lock access aperture 164.

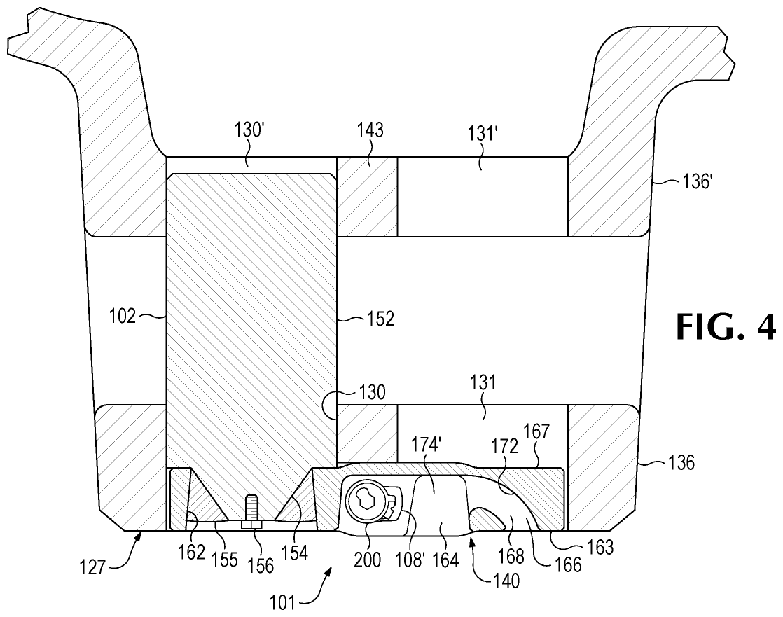

In the illustrated example, the tool access opening 166 is an elongate groove that passes through the front face 163 of the retainer body 160 and curves toward and communicates with the lock access opening 164 (best seen in FIG. 4). The tool access opening 166 includes an elongate opening 168 on the front face 163 of the retainer body 160. The tool access opening 166 is J-shaped or a quarter circle passage (when viewed in section from above) having inner surface 170 and outer surface 172. A tool (not shown), such as a hook, can be installed into the tool access opening 166 to couple to the pin assembly 101 and/or body 60 for removal, installation, or lifting thereof. The tool may be supported by a crane or cable or other arrangement for installation and/or removal. The tool access aperture 166 may be easier to manufacture than conventional protruding lifting eyes and less likely to wear during use of the excavating bucket 110, thereby improving the likelihood that it is still accessible at the time of removal of the pin assembly 101 and/or body 60.

The lock access aperture 164 opens to the front face 163 of the retainer body 160. The illustrated lock access aperture 164 includes two lock passages 108, 108′, each passage being axially offset from the other and being transverse to a pin body direction B. It is understood that one or more than two lock passages could be used. The lock access aperture 164 is comprised of two cavities 174, 174′. Each cavity 174, 174′ is situated adjacent the respective lock passage 108, 108′ and opposite the other lock passage 108′, 108, respectively. The lock access aperture 164 is sized and shaped such that the cavities 174, 174′ are staggered from one another to create a sideways Z-shape pattern. Locks 200 are sized and shaped to be installed into the lock passages 108,108′. The cavities 174, 174′ are sized and shaped in such a way that a lock 200 can be inserted into the cavity 174 and lowered or raised into the lock passage 108, 108′. The cavities 174, 174′ are sized and shaped such that a tool (e.g., a ratchet wrench) can be inserted into the cavity 174, 174′ to manipulate the lock 200. The lock access aperture 164 may be sealed with a wear plate to protect the locks 200 though this is not necessary.

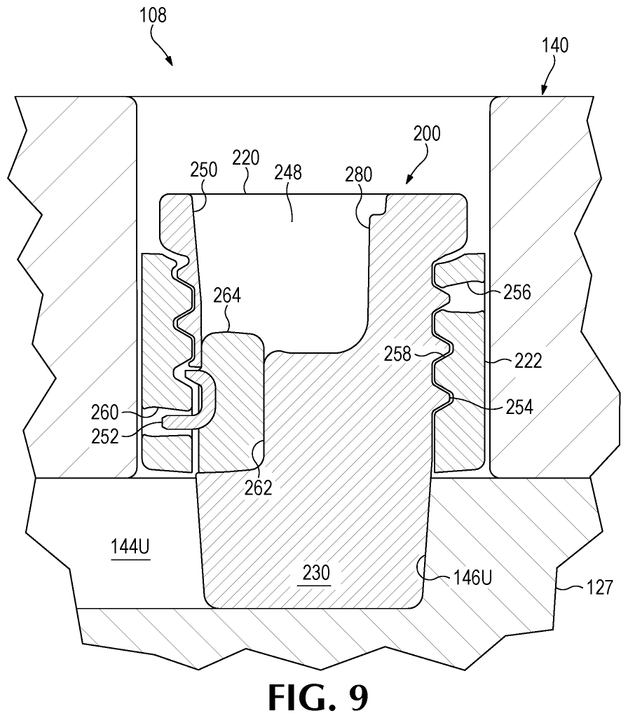

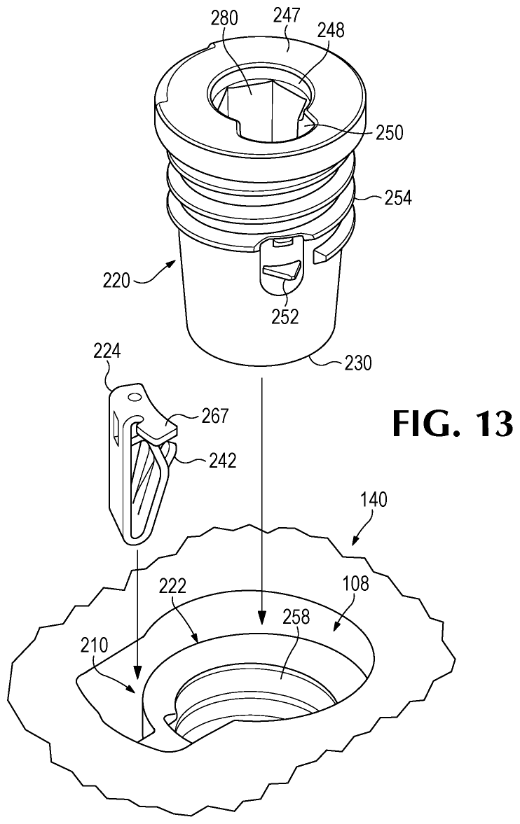

Lock 200 is generally shown in FIGS. 7-13. Each lock 200 is integrally installed in one of the lock passages 108, 108′ so that it is retained in both the released position and the locked position. The pin assembly 101 and/or body can be disassembled, assembled, repositioned, without the lock 200 being dropped or lost. This can significantly improve maintenance procedures, reduce downtime for excavating equipment, and improve safety as it reduces the need for separate handling of the lock 200. Searching for a dropped component at night can be difficult and can put personnel in a hazardous situation underneath heavy components.

Each lock 200 is retained in a lock passage 108, 108′ to limit axial movement of the pin 102 when installed in either of the openings 130,130′ or 131, 131′. The lock passages 108, 108′ are illustrated in opposite edges of the side surface 167 and the installation of one lock 200 is opposite the other. The lock passage 108, 108′ tends to protect the locks 200 from the abrasive earthen material. Each lock 200 includes a lock pin 220 received in a mounting component or collar 222 mechanically retained in the lock passage 108, 108′. The collar 222 contains features supportive of integrated shipment, load transmission, and lock installation and removal. The lock pin 220 and collar 222 are preferably threaded so that pin 220 helically advances through the center of the collar 222 between two low energy positions created by an elastomer backed latching mechanism 252.

The first position, (e.g., with a half turn of thread engaged between the collar 222 and the lock pin 220) is a release position where the lock pin 220 is preferably retained during shipment, storage, installation and removal. The lock pin 220 advances into the second low energy position after rotating (e.g., two half turns, i.e. a full turn) ending preferably in a hard stop signaling that the lock system 200 is locked. When the pin 102 requires removal, the lock pin 220 is rotated counterclockwise to retract the lock pin 220 back into the release position or the lock 200 may be removed. In a preferred construction, slots 144U, 144L engage the lock pin end 230 to hold the lock pin 220 (and ultimately the pin assembly 101) in place, and from which the lock pin 220 is retracted to allow the pin 102 to slide free from openings 130, 130′ or 131, 131′ in the trunnion 127. Other arrangements to facilitate effective engagement of the lock pin 220 and the pin 102 could be used.

A lock 200 includes a mounting component or collar 222 and a retaining component or lock pin 220 (FIGS. 7, 8, 9 and 13). Collar 222 fits in passage 108 of lock access aperture 162 and includes a bore or opening 223 with threads 258 for receiving lock pin 220 with matching threads 254. A retainer 224, preferably in the form of a retaining clip, is inserted in passage 108, 108′ with collar 222 to prevent disengagement of the collar 222 from passage 108. Preferably, a retainer or clip 224 is inserted during manufacture of retainer 140, so that lock 200 is integrally coupled with retainer 140 (i.e., to define a retainer 140 that integrally includes a lock 200) for shipping, storage, installation and/or use of the retainer. Such a construction reduces inventory and storage needs, eliminates dropping the lock 200 during installation (which can be particularly problematic at night), ensures the proper lock 200 is always used, and eases the installation of the pin assembly 101. Although the lock 200 is preferably always retained in the component, retainer 224 could be made to be removable to permit removal at any time so as to effect removal of lock 200.

Collar 222 has a cylindrical body 225 with lugs 236, 237 that project outward to contact and bear against bearing surfaces of retaining structure 202 in the lock passage 108 to hold lock 200 in place in lock passage 108. To install collar 222, body 225 is inserted into passage 108 from within lock opening 164 such that lugs 236, 237 are slid along passage 108. Collar 222 is preferably translated in a transverse direction of the opening 164 of the passage 108 until flange 241 is received in passage 108. Collar 222 is then rotated until lugs 236, 237 straddle retaining structure 202. The rotation of collar 222 is preferably approximately thirty degrees so that lugs 236, 237 move into upper reliefs 204, 206. The engagement of lugs 236, 237 against both sides of retaining structure 202 hold collar 222 in passage 108 even under load during digging by the excavating bucket 110. Further, the cooperation of outer lug 236 and flange 241 provide a resistive couple against cantilever loads applied to lock pin 220 during use.

Once the collar 222 is in place, the retainer 224 is inserted into passage 108. Preferably, the retainer 224 is snap-fit into a slot 210 along passage 108, thereby preventing rotation of collar 222 so that lugs 236, 237 are retained in reliefs 204, 206. Retainer 224 is preferably formed of sheet steel with a bent tab 242 that snaps into a receiving notch 244 on an outer surface 246 of collar 222 to hold retainer 224 in retainer 140. The retainer 224 allows collar 222 to be locked in the passage 108 for secure storage, shipping, installation and/or use, and thereby define a part of retainer 140. A retainer flange 267 is preferably provided to abut lug 236 and prevent over-insertion of the retainer 224.

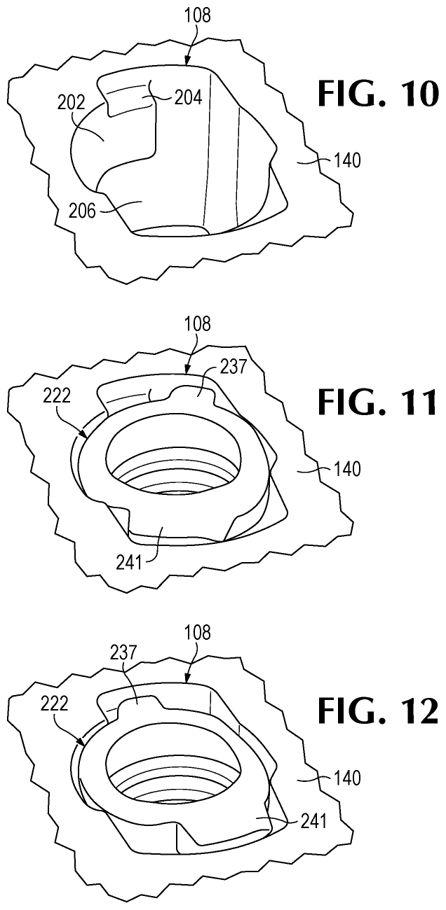

The engagement of lugs 236, 237 against retaining structure 202 mechanically holds the collar 222 in passage 108 and effectively prevents inward and outward movement during shipping, storage, installation and/or use of retainer 140 (FIGS. 10-12). The collar 222 is preferably a single unit (one piece or assembled as a unit), and preferably a one-piece construction for strength and simplicity. The retainer 224 is preferably formed of sheet steel as it does not resist the heavy loads applied during operations. The retainer 224 is used only to prevent undesired rotation of the collar 222 in passage 108 so as to prevent release of lock 200 from retainer 140. Nevertheless, other arrangements for securing collar 222 in passage 108, 108′ could be used.

Lock pin 220 includes a head 247 and a shank 249. Shank 249 is formed with threads 254 along at least a portion of its length from head 247. Pin end 230 is preferably unthreaded for receipt into slots 144U,144L in trunnion bracket 127. Lock pin 220 is preferably installed into collar 222 from inside the lock access opening 164 so that pin end 230 is the leading end and pin threads 254 engage collar threads 258. A hex socket (or other tool-engaging formation) 248 is formed in (or on) head 247, at the trailing end, for receipt of a tool to turn lock pin 220 in collar 222.

Locks 200 are preferably used to secure pin assembly 101 and/or body 60 to the trunnion bracket 127. In the illustrated embodiment, a lock 200 is first installed into one passage 108, and then a second lock 200 is installed in the same way in the opposite direction in passage 108′, though either lock can be secured first. In a preferred construction, two locks 200 are installed into passages 108, 108′ in opposite directions to hold pin 102 to trunnion bracket 127. Alternatively, one lock 200 could be used to secure the pin to the wear component, or more than two locks could be used. Alternatively, other kinds of lock or configurations could be used in lieu of or in addition to locks 200.

In one preferred example, threaded lock pin 220 includes a biased latching tooth or detent 252, biased to protrude beyond the surrounding thread 254. A corresponding outer pocket or recess 256 is formed in the thread 258 of collar 222 to receive detent 252, so that threaded lock pin 220 latches into a specific position relative to collar 222 when latching detent 252 aligns and connects with outer pocket 256. The engagement of latching detent 252 in outer pocket 256 holds threaded lock pin 220 in a release position relative to collar 222, which holds lock pin 220 with sufficient clearance outside of slot 144U, 144L on the trunnion 127. The lock pin 220 is preferably shipped and stored in the release position so that pin assembly 101 is ready to install. Preferably, latching detent 252 is located at the start of the thread on threaded lock pin 220. Outer pocket 256 is located preferably approximately a half rotation from the start of the thread on collar 222. As a result, lock pin 220 will latch into shipping or release position after approximately half a turn of lock pin 220 within collar 222. Other arrangements are, of course, possible. A detent could alternatively be supported by the collar 222 and fit into a recess in the locking pin 220.

Further application of torque to lock pin 220 will squeeze latching detent 252 out of outer pocket 256. An inner pocket or recess 260 is formed at the inner end of the thread of collar 222. When lock pin 220 is installed into collar 222, it is preferably rotated half a turn to the release position for shipping, storage and/or installation of pin assembly 101. Lock pin 220 is then preferably rotated a full turn until pin end 230 is fully received into slot 144U, 144L in the locked or service position. More or fewer rotations of threaded lock pin 220 may be needed, depending on the pitch of the threads, and on whether more than one start is provided for the threads. The use of a particularly coarse thread requiring, e.g., only three full rotations of threaded lock pin 220 for full locking of a pin 102 to trunnion bracket 127 has been found to be easy to use in field conditions, and reliable for use under the extreme conditions of excavation. Furthermore, the use of a coarse helical thread is better in installations where the pin assembly 101 will become surrounded by compacted fines during use.

Preferably, lock 200 is recessed in passage 108, 108′ so that it remains shielded from moving earthen material over the life of the pin assembly 101. Earthen material will tend to accumulate in passage 108, 108′ to cover lock 200 and protect the lock 200 from undue wear even as other components of the pin assembly 101 and trunnion bracket 127 wear. Further, the lock 200 is generally centrally located in lock passage 108, 108′ with pin end 230 located at or proximate the end 146U, 146U′, 146L, 146L′ of the respective slot 144U, 144L in the locked position.

To remove the lock 200, pin 102 may be released using a ratchet tool or other tool to unscrew lock pin 220 from collar 222. Although the lock pin 220 can be removed from collar 222, it need only be backed up to the release position. The pin assembly 101 can then be removed from trunnion 127. The torque of unscrewing lock pin 220 may exert substantial torsion loads on collar 222, which loads are resisted by engagement with retaining structure 202, providing a strong and reliable stop for lugs 236 and 237.

The mounting component or collar 222 of lock 200 defines a threaded bore 223 for receiving the threaded securing lock pin 220 that is used to releasably hold pin 102 to trunnion bracket 127. The separate mounting component 222 can be easily machined or otherwise formed with threads, and secured within the lock passage 108, 108′ for less expense and higher quality threads as compared to forming the threads directly in the lock passage 108, 108′. The mounting component 222 can be mechanically held within the lock passage 108, 108′ in the slot 144U, 144L to resist axial movement in either direction (i.e., that is in and out of passage 108) during use. The collar 222 can be mechanically held within the lock passage 108, 108′ so as to better resist unintended loss of the lock 200 during shipping, storage, installation and use. On account of the hard steel typically used for retainer 140, mounting component 222 could not be easily welded into passage 108. Nevertheless, threads or partial threads could be formed in channel 108, 108′ or the collar 222 could be welded in channel 108, 108′.

The use of a lock 200 in accordance with the above example provides many benefits: (i) a lock integrated into a retainer 140 or pin assembly 101 so that the lock 200 ships and stores in a ready to install position for less inventory and easier installation; (ii) a lock 200 that requires only common drive tools such as a hex tool or ratchet driver for operation, and requires no hammer; (iii) new locks 200 provided with each wear part; (iv) a lock 200 that is positioned for easy access in lock access aperture; (v) a lock 200 with a simple, intuitive and commonly understood operation; (vi) a lock 200 integration system built around simple castable feature where the integration supports high loads, requires no special tools or adhesives and creates a permanent assembly.

To install the pin assembly 101 when the pin and retainer are fixed together (e.g., after welding of the pin 102 to the retainer 140), the pin 102 is inserted into either of the holes 130,130′ or 131, 131′, and the retainer 140 is received into the retainer opening 142. The aligned openings 130, 130′, 142 in the first position or 131, 131′, 142 in the second position accept a pin assembly 101.

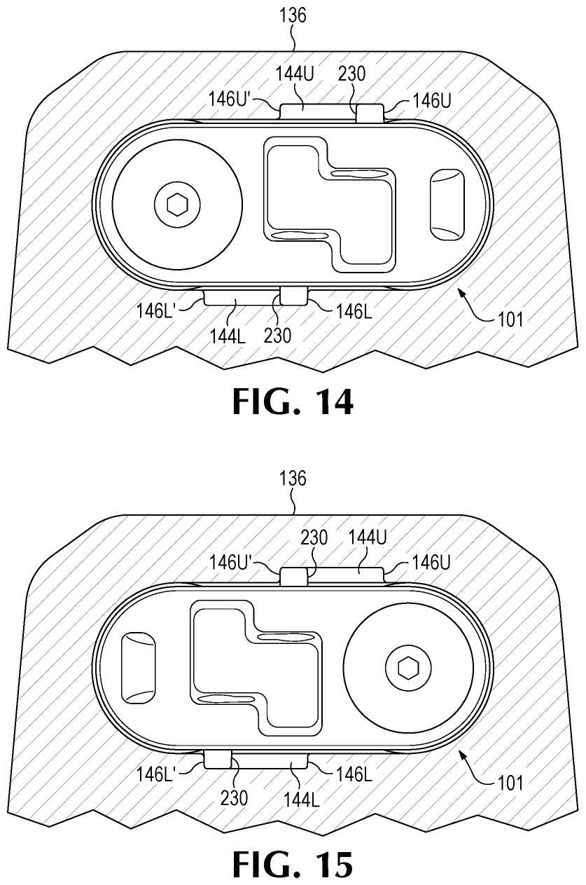

In FIG. 14, the trunnion pin 102 is inserted into the set of pin holes 130, 130′ (FIG. 6). The locks 200 may already be positioned within the retainer 140 in a release position, and are rotated with a tool into the locked position, such that the locks 200 engage ends 146L and 146U of slots 144L and 144U in a first position of the pin assembly 101. In this illustration, the pin assembly 101 is fixed (i.e., pin 102 is welded or otherwise secured to retainer 140) and does not rotate during operation. The pin, though, could remain unsecured to the retainer and either rotate in the bracket or be secured against rotation by a different construction.

In FIG. 15, the trunnion pin 102 is inserted into the second pin holes 131, 131′ (FIG. 6). The locks 200 may already be positioned within the retainer 140 in a release position. The locks 200 are rotated with a tool into the locked position, such that the locks 200 engage ends 146U′ and 146L′ of slots 144U and 144L in a second position of the pin assembly 101.

To remove the pin assembly 101, the locks 200 are positioned into a release position still within the lock passage 108, 108′ and the pin assembly 101 is removed from holes 130, 130′, 142 (when the pin assembly 101 is in the first position) or from holes 131,131′, 142 (when the pin assembly 101 is in the second position). In either position, the pin assembly 101 is removed by securing a hook (or other coupler) via the tool access aperture 166 and/or a hook with a threaded stem (or other coupler) into hole 156A connected to a crane (or other equipment), and applying a pulling force.

Alternatively, the pin 102 could be installed into the bracket, followed by installation of the retainer 140 into opening 142. If the pin and retainer are to be fixed together, they can be welded together after installation in the bracket. Likewise, for disassembly, the retainer could be removed without the pin if the weld is omitted or previously cut out. The pin, then, could be removed once the retainer has been removed.

It will be appreciated that if the pin assembly 101 is aligned with, but not inserted into, the first position, then it can be inserted into the second position by rotating the pin assembly 101 by 180° degrees prior to insertion thereof.

The various features of the present disclosure are preferably used together in a dragline bucket. These configurations were used in combination and can ease operation and maximize performance. Nonetheless, the various features can be used separately or in limited combinations to achieve some of the benefits of the disclosure.

The disclosure is disclosed above and in the accompanying figures with reference to a variety of configurations. The purpose served by the disclosure, however, is to provide an example of the various features and concepts related to the disclosure, not to limit the scope of the disclosure. One skilled in the relevant art will recognize that numerous variations and modifications may be made to the configurations described above without departing from the scope of the present disclosure.

1. A pin assembly comprising:
a component including a pin hole and a retainer opening;
a pin received in the pin hole; and
a retainer fixed to the pin and releasably secured within the retainer opening to prevent the removal from and the turning of the pin in the pin hole.

2. The pin assembly of claim 1 wherein the component includes another pin hole, the pin holes are spaced from each other to alternatively receive the pin, and the retainer releasably retains the pin when the pin is received in either of the pin holes.

3. The pin assembly of claim 1 wherein the retainer includes a body having opposite sides, a pair of locks secured to the body with one said lock associated with each of the opposite sides, and each said lock includes a retaining member movable inward and outward of the body to releasably secure the retainer in the retainer opening.

4. The pin assembly of claim 3 wherein the body includes a lock access opening enabling access to enable operation of the locks.

5. The pin assembly of claim 3 wherein each of the locks has a collar secured to the retainer and a lock pin threaded into the collar for translating when turned between a hold position for securing the retainer in the retainer opening and a release position for permitting installation of the retainer into the retainer opening.

6. The pin assembly of claim 1 wherein the retainer includes a tool access opening to facilitate removal of the retainer from the retainer opening.

7. The pin assembly of claim 1 wherein the retainer and the pin each include a tool access opening to facilitate attachment of a coupler thereto for removal of the retainer from the retainer opening.

8. The pin assembly of claim 1 wherein the component is a rigging component.

9. The pin assembly of claim 1 wherein the component is a trunnion bracket for a dragline bucket.

10. A pin assembly comprising:
a component including a pin hole and a retainer opening, wherein the pin hole is aligned with the retainer opening,
a pin received in the pin hole; and
a retainer received in the retainer opening to prevent removal of the pin from the pin hole, wherein the retainer includes at least one lock to releasably secure the retainer in the opening.

11. The pin assembly of claim 10 wherein the pin is fixed to the retainer such that the pin and the retainer move as one piece.

12. The pin assembly of claim 10 wherein the component includes another pin hole, the pin holes are spaced from each other to alternatively receive the pin, and the retainer releasably retains the pin when the pin is received in either of the pin holes.

13. The pin assembly of claim 10 wherein the retainer includes a body having opposite sides, the at least one lock includes a pair of locks secured to the body with one said lock associated with each of the opposite sides, and each said lock includes a retaining member movable inward and outward of the body to releasably secure the retainer in the retainer opening.

14. The pin assembly of claim 13 wherein the body has a lock access aperture enabling access to enable operation of the locks.

15. The pin assembly of claim 10 wherein the at least one lock has a collar secured to the retainer and a lock pin threaded into the collar for translating when turned between a hold position for securing the retainer in the retainer opening and a release position for permitting installation of the retainer into the retainer opening.

16. The pin assembly of claim 10 wherein the retainer includes a body having a pin opening for receiving at least a portion of the pin, the retainer is secured to the pin such that the pin does not move independently of the retainer, the at least one lock is secured to the body and operable to releasably secure the retainer to the rigging component, and a lock access opening enabling access to enable operation of the at least one lock.

17. The pin assembly of claim 16 wherein the portion of the pin received into the pin opening is welded to the retainer.

18. The pin assembly of claim 10 wherein the component is a rigging component for an earth working operation.

19. The pin assembly of claim 10 wherein the component is a trunnion bracket for a dragline bucket.

20. A dragline bucket comprising:
a shell including opposite sidewalls, each of the sidewalls having a trunnion bracket for securing to a rigging component, each said trunnion bracket defining a pin hole and a retainer opening;
a pin received in the pin hole; and
a retainer received in the retainer opening to prevent removal of the pin from the pin hole, wherein the retainer includes at least one lock to releasably secure the retainer in the opening.
